(19) United States
(12) Patent Application Publication
(10) Pub. No.: US 2013/0097017 A1
(43) Pub. Date: Apr. 18, 2013

(54) Methods and systems for creating an intelligent online lead generation system connecting retail vendors with home buyers, sellers and renters in real estate transaction and move cycle

(71) Applicants: Subrao Venugopal Shenoy, San Jose, CA (US); Seema Subrao Shenoy, San Jose, CA (US)

(72) Inventors: Subrao Venugopal Shenoy, San Jose, CA (US); Seema Subrao Shenoy, San Jose, CA (US)

(21) Appl. No.: 13/317,304

(22) Filed: Oct. 14, 2011

(51) Int. Cl. G06Q 30/02; G06Q 50/16

(52) U.S. Cl. 705/14.49; 705/26.2; 705/1.1

(57) ABSTRACT

The invention relates to online social commerce system targeting products and services towards active home buyers and sellers.

This invention is built on top of Business Intelligence (BI) and workflow contained inside complex real estate transactions conducted every year. With a growing valuable database of consumers and several million documents vaulted each year; this invention uses intelligence in these transactions for exact target profiling and timing of these high value leads to retail vendors.

The core of the invention is the transaction platform that automates all transactional business processes, workflow, documents and compliance to real estate brokerages.

The invention can generate reports or match complex data contained inside the transaction to help the vendor get the exact leads they need to target the exact product and service profile for the buyer or seller at right time.

### COPYRIGHT NOTICE

A portion of the disclosure of this patent documentation contains material that is subject to copyright protection. The copyright owner has no objection to the facsimile reproduction by anyone of the patent document or the patent disclosure, as it appears in the Patent and Trademark Office Patent file or records, but otherwise reserves all copyright rights whatsoever.

### SUMMARY OF INVENTION

The invention includes a method of generating simple to complex workflows for multiple participants in a transaction driven by the nature of the contract and the type of property chosen.

These workflows have specific milestones in the event calendar which is used as one of the basis for lead triggering.

In one embodiment, the invention may be configured to trigger a high value lead campaign for the buyer when the loan is approved. This creates a major social commerce event that the buyer in this case has secured financing and will most likely move in to this property and hence as a corollary will be in need of certain products and services that this invention is designed to handle.

In another aspect of the invention, events may be triggered by scheduling and post analyzing the documents in multiple reports stored after the closing of the home purchase cycle; e.g. need for a new roof in 6 months or pool replacement or any other changes needed to retrofit the property based on inspection reports. This will also create a high social commerce event for the vendors to send leads to that consumer just in time.

In another aspect of the invention, detailed demographic, financial and transactional profile of the consumer is used to target the near exact product or service needed. Young couple buying first home, retirees moving to a smaller home, investor buying rental properties have different needs for products and services needed to fulfill in the transaction which the system is designed to handle.

### BRIEF DESCRIPTION OF THE DRAWINGS

FIG. 1 shows one sample illustrative diagram of a typical buying/selling home transaction and move cycle for a consumer.

FIG. 2 is a block diagram the Lead Generation and Revenue Flow in the invention

FIG. 3 is a diagram showing a typical workflow of a transaction that can generate key timers to trigger high value advertisements and coupons

### DETAILED DESCRIPTION OF THE PREFERRED EMBODIMENT

The present invention is configured as a software system that is capable of connecting consumers in a buy/sell or a rental home transaction cycle with retail vendors furnishing these products and services.

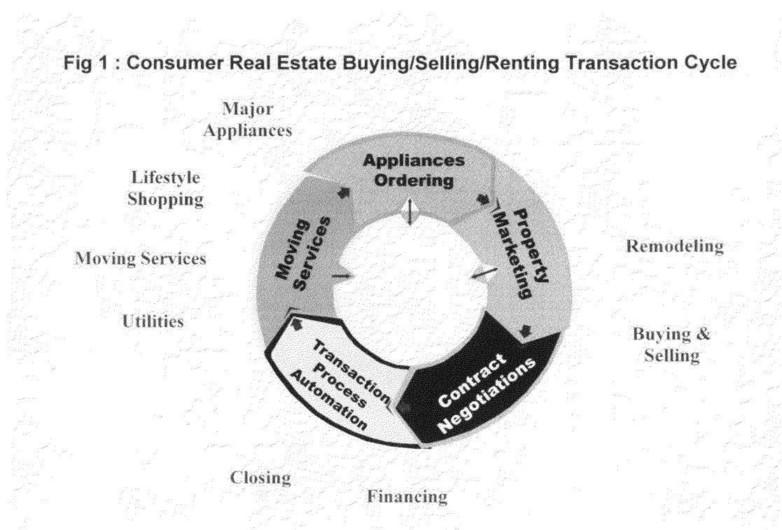

FIG. 1 shows a sample flow of such a transaction and move cycle. In the property marketing stage, the consumer is looking at marketing the property (e.g. seller). They also engage in some remodeling that could generate leads for businesses and vendors that specialize in landscaping and remodeling. Once the transaction goes in the contract stage (purchase or rental); the transaction platform software generates complete workflow and document management based on the specifics of the transaction type and connects all the transaction participants and vendors in the flow.

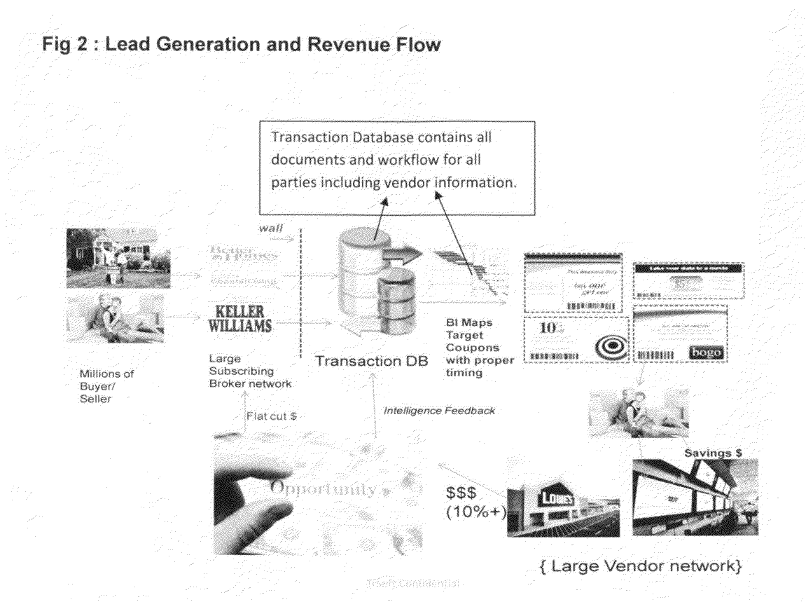

As shown in FIG. 2; the invention understands all the transaction details contained in the flow. The business intelligence understands key dates and triggers lead generation done for participating vendors based on life cycle stage, income, demographic and other parameters. These leads are sent out as email or coupon campaigns on behalf of the vendor to the consumer OR could be shown as display advertisements.

The coupons are then cashed by the consumers at the stores for discounts and the system in turn increases its intelligence based on results, for targeting the coupons better the next time. The vendor allow revenue share with the provider of this service including lead auctioning.

The invention also involves as shown in FIG. 2 the ability to analyze documents and reports contained in real estate transaction that are stored in the transaction platform database to understand upcoming events coming up. As an example, a specific home being rented or sold may be required to have a roof replaced in 3 months and such intelligence can be mined for creating leads and ecommerce events as before.

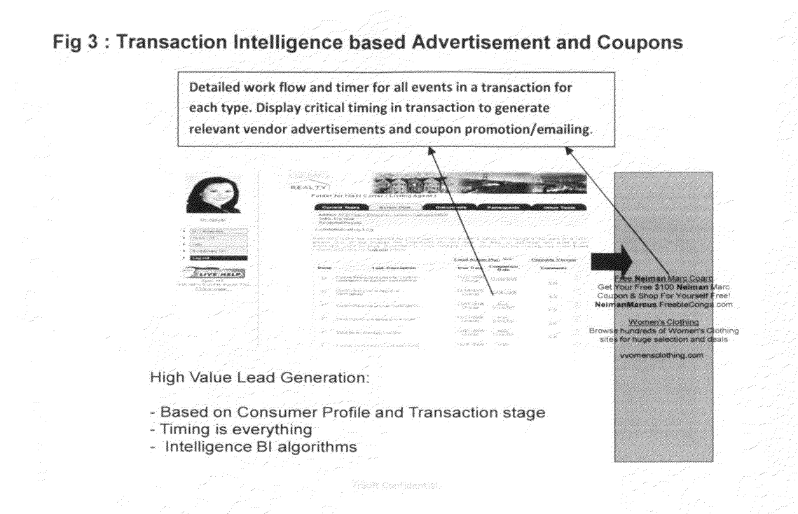

FIG. 3 shows a specific software implementation showing all the workflow elements in a transaction and ability of the invention to generate specific banner advertisements in addition to emailing coupons and promotions. All workflows shown are relevant to each party (buyers/sellers, renters/landlords) as they fulfill their requirements in this transaction cycle.

The features and functions of the invention may be implemented by encoding computer readable software in the form of Microsoft .NET, AJAX, C++ and SQL language or other computer readable formats that can configure a computer or server to perform the features and functions.

The invention may be designed and implemented on a computer and may be connected to a network for communication with many other computers to practice the invention. A system configured to operate according to the invention may include a plurality of PCs, Tablets or mobile PDAs connected to the Internet via individual modems or other communication means such as Wi-Fi and Wireless 3G/4G communications. The invention may involve a number of functions to be performed by a computer processor, such as a microprocessor. The microprocessor may be specialized or dedicated microprocessor that is configured to perform certain tasks by executing machine readable software code for a particular task. The microprocessor may be configured to operate and communicate with other devices such as direct memory access modules, memory storage devices, internet related hardware and other devices that relate to the transmission of data in accordance with this invention. The software code may be configured using software formats like C++, C#, SQL, AJAX , SQL and XML language that may be used to define and present information that relate to operations of devices required to carry out the functional operations related to the invention. The code may be written in many forms and styles in the art of computer programming. Different code formats, code configurations, styles and forms of software programs and other means to configure and release the operation of the microprocessor in accordance with the invention will not depart from the spirit and scope of the inventions, which is defined by the detail description as well as subparts included therein.

The invention is directed to an apparatus for receiving and processing lead generated data from a real estate buy/sell or a rental transaction. The invention may also include a dedicated processor configured to communicate with computers that communicate among one or more networks to receive and transmit data packets related to performing this task. However, it will be appreciated by those skilled in the art, that this is illustrative of only one utility of the invention, and that the invention has greater applicability and utility in many other applications where efficient routines and processing of data for performing online lead generation with one or more networks is involved. Equivalent structures embodying the invention could be configured for such applications without diverting from the spirit and scope of the invention. Although this embodiment is described and illustrated in the context of modern databases, the invention extends to other applications where similar features are useful. Furthermore, while the foregoing description has been with reference to particular embodiments of the invention, it will be appreciated that these are only illustrative of the invention and that changes may be made to those embodiments without departing from the principles of the invention, the scope of which is defined by this overall description or any subparts herein.

1. An intelligent online lead generation system to match and connect retailers providing relevant home products and services with home buyers, sellers, renters and landlords of real estate during the transaction, post transaction and move cycle.

2. The system of claim 1, wherein a built in transactional platform connecting multiple parties in a transaction is used underneath as a basis for deriving intelligence inside the transaction; to specifically create, profile and deliver with high accuracy—using online advertisements and coupons via web site and/or emails, texting, micro blogging with the purpose of matching and connecting the buyer, seller or renter/landlord in a home transaction with vendors who provide the relevant products and services.

3. The system of claim 1, wherein complex business rules can be created and used to accurately match and connect only certain type of buyer and sellers of a home and vendors based on age of consumer, demographic profile, transaction profile, income level, life cycle moves to match with pricing, taste, lifestyle reflected in relevant products and services offered by the vendor.

4. The system of claim 1, wherein the business intelligence in transaction documents are electronically analyzed to map the relevance and timing of a specific product service from the vendor.

5. The system of claim 1, wherein the intelligence in specific transaction workflows of different parties involved in a transaction are electronically used and analyzed to map the relevance and timing of a specific product service from the vendor to the buyer and/or seller.

6. The system of claim 1, wherein the intelligence is specifically applied to but not limited to a home purchase or rental transaction but could be used for commercial real estate

7. A new ONLINE SOCIAL COMMERCE software business model that offer this system FREE to brokerages that participate in the program, in exchange for enabling access to transaction data and intelligence on their deals and secure an additional referral fee on all advertisement and coupon revenues generated by such a system.

8. The system of claim 7, wherein the revenue model prices the lead based upon the time window of the transaction cycle to ensure high relevancy.
